(19) United States
(12) Patent Application Publication
(10) Pub. No.: US 2026/0186462 A1
(43) Pub. Date: Jul. 2, 2026

(54) NONLINEAR PHYSICAL COMPUTING ARCHITECTURE WITH DOMAIN-WIDE PARAMETER-FIELD RESHAPING, ATTRACTOR-LANDSCAPE MODIFICATION, GRADIENT PERSISTENCE MODULATION, AND MULTI-DOMAIN ORCHESTRATION

(71) Applicant: Anil P. Rami, MOUNDSVILLE, WV (US)

(72) Inventor: Anil P. Rami, MOUNDSVILLE, WV (US)

(21) Appl. No.: 19/549,231

(22) Filed: Feb. 25, 2026

(51) Int. Cl. G05B 15/02; G06F 17/13

(52) U.S. Cl. CPC G05B 15/02; G06F 17/13

(57) ABSTRACT

A nonlinear physical computing architecture comprising a continuous nonlinear domain in which excitation produces persistent reshaping of at least one spatially continuous parameter field. Said reshaping alters non-local coupling coefficients of governing nonlinear equations and modifies attractor basin topology. Subsequent excitation follows a measurably reduced state-space trajectory length relative to baseline measured following reset. Persistence magnitude may be continuously modulated, and multiple domains may be orchestrated in staggered reset configurations. The architecture excludes discrete memory cells and programmable weight matrices.

### CROSS-REFERENCE TO RELATED APPLICATIONS

This application claims the benefit of U.S. Provisional Patent Application Ser. No. 63/983,444 , titled “Nonlinear Physical Computing Architecture with Persistent Spatial Redistribution, Gradient Persistence Modulation, and Regime Orchestration,” the entirety of which is incorporated herein by reference.

This application is related to U.S. patent application Ser. No. 19/452,222, titled “Field-Based Light Computing Without Stored Topology,” and U.S. patent application Ser. No. 19/455,843, titled “Field-Based Computation Using Stored Excitation as Memory and Physical Evolution as Computation,” the entirety of each being incorporated herein by reference.

This application is further related to U.S. patent application Ser. No. 19/547,362, titled “Nonlinear Physical Computing Apparatus with Persistent Spatially Distributed Parameter Redistribution and Reset-Verified Dynamic Convergence Kinetic Acceleration,” the entirety of which is incorporated herein by reference.

The present disclosure extends and further develops nonlinear persistence mechanisms and architectural structures disclosed in the above-identified applications while introducing attractor-landscape reshaping, gradient persistence modulation, and multi-domain orchestration.

### FIELD OF THE INVENTION

The present invention relates to nonlinear physical computing systems implemented in continuous physical media in which excitation produces persistent reshaping of spatially continuous governing parameter fields.

More particularly, the invention relates to architectures in which persistent reshaping modifies intrinsic nonlinear evolution dynamics, alters attractor basin topology, enables reduction in state-space trajectory length, supports continuously variable persistence magnitude modulation, and enables coordinated multi-domain persistence governance.

### BACKGROUND OF THE INVENTION

Conventional electronic and photonic computing architectures encode computational function within fabricated routing topology, discrete logic elements, or symbolic memory structures.

Even advanced neuromorphic and memristive systems typically rely upon discretized addressable conductance elements or programmable weight matrices to encode computational structure.

Prior field-based computing architectures have eliminated stored routing topology, allowing computation to arise from transient physical field evolution.

Subsequent architectures have unified memory and computation by treating stored excitation within a medium as memory and physical evolution as computation.

Further developments demonstrate that excitation-induced persistent redistribution of governing material parameters may measurably accelerate nonlinear convergence when verified through reset-controlled baseline comparison.

However, prior systems do not require modification of governing nonlinear differential equation coefficients through domain-wide reshaping of spatially continuous parameter fields.

Prior systems do not explicitly require alteration of attractor basin topology as a structural dynamical consequence of persistent reshaping.

Prior systems do not require measurable reduction in state-space trajectory length independent of convergence timing.

Prior systems do not provide continuous modulation of persistence magnitude as a tunable computational control dimension.

Prior systems do not provide coordinated orchestration of multiple nonlinear domains operating at differing persistence depths with staggered reset scheduling.

Accordingly, there exists a need for a nonlinear physical computing architecture in which persistent parameter-field reshaping functions as a topological dynamical control layer within a continuous nonlinear domain.

### SUMMARY OF THE INVENTION

The present invention provides a nonlinear physical computing architecture comprising a continuous nonlinear physical domain governed by differential equations dependent upon at least one spatially continuous parameter field.

The architecture includes at least one excitation interface configured to induce persistent reshaping of said parameter field.

Persistent reshaping modifies non-local coupling coefficients of governing nonlinear equations and alters attractor basin topology of the nonlinear dynamical system.

In certain embodiments, subsequent excitation follows a measurably reduced state-space trajectory length relative to baseline measured following reset of reshaping.

In certain embodiments, magnitude of reshaping is continuously variable and convergence behavior varies monotonically as a function of reshaping magnitude.

In certain embodiments, the system comprises a plurality of nonlinear domains configured for coordinated persistence-state orchestration, wherein at least one domain processes excitation while at least one other domain undergoes reset or controlled decay.

The architecture excludes discrete memory cells, programmable weight matrices, stored routing topology, and matrix multiply-accumulate computational structures.

### DETAILED DESCRIPTION OF THE INVENTION

### Governing Nonlinear Evolution Framework

The computing architecture comprises a physically continuous nonlinear domain in which internal state variables evolve according to intrinsic physical interaction laws.

State variables may include, without limitation, optical field amplitudes, phases, electric field distributions, ionic concentration fields, magnetization vectors, superconducting phase variables, mechanical strain fields, acoustic fields, or coupled multi-physics variables.

In certain embodiments, the evolution of the system may be described by a nonlinear dynamical equation of the form:

$$\partial X / \partial t = F ( X ; P ( x ) , B )$$

Where X represents one or more state variables of the domain, P(x) represents one or more spatially continuous governing parameter fields, and B represents boundary conditions and external forcing terms.

The functional F is nonlinear with respect to X and depends upon spatial coupling mediated by P(x).

### Parameter Fields as Governing Coefficients

The parameter field P(x) may comprise one or more spatially continuous distributions including, without limitation:
(a) Refractive index distribution n(x);
(b) Electrical conductivity distribution σ(x);
(c) Ionic mobility distribution μ(x);
(d) Magnetic anisotropy distribution K(x);
(e) Superconducting phase stiffness α(x);
(f) Nonlinear interaction coefficients χ(x);
(g) Mechanical modulus distribution E(x).

The parameter field P(x) governs spatial coupling between regions of the domain and directly influences coefficients of the nonlinear evolution equation.

Persistent reshaping of P(x) results in modification of effective coupling coefficients such that:

$$F\_modified ( X ) \neq F\_baseline ( X )$$

under substantially identical excitation and boundary conditions.

### Domain-Wide Parameter-Field Reshaping

Excitation applied to the nonlinear domain may comprise optical radiation, electrical bias, magnetic field application, mechanical strain, thermal stimulus, or combinations thereof.

Excitation produces spatial redistribution of at least one governing parameter field P(x).

Redistribution persists beyond cessation of excitation for a duration sufficient to influence subsequent nonlinear evolution.

In certain embodiments, redistribution extends beyond the characteristic excitation scale, thereby modifying non-local coupling between spatially separated regions.

Domain-wide reshaping is defined as reshaping sufficient to alter global dynamical behavior of the system rather than merely local perturbation.

### Non-Local Coupling Modification

Non-local coupling refers to dependence of local state evolution at position x₁ upon state variables at position c₂ mediated by the spatial structure of P(x).

Persistent reshaping may modify diffusion coefficients, propagation velocities, nonlinear gain or loss parameters, stability eigenvalues of fixed points, or effective interaction strengths.

Such modification alters the global dynamical flow of the system in state space.

### Attractor Basin Topology Modification

The nonlinear dynamical system may exhibit one or more attractor basins corresponding to stable steady states, oscillatory regimes, metastable states, or chaotic regimes.

Persistent reshaping modifies attractor basin topology through alteration of:
(a) Location of fixed points;
(b) Stability eigenvalue spectra;
(c) Basin boundary geometry;
(d) Separatrix structures between attractors;
(e) Bifurcation thresholds.

Alteration of attractor topology constitutes structural modification of system dynamics rather than transient acceleration alone.

### State-Space Trajectory-Length Formalization

Trajectory length L in state space may be defined as:

$$L = {\int }_{0}^{T} ‖ dX / dt ‖ dt$$

where T represents time to reach a defined stabilization condition.

Persistent reshaping modifies dynamical flow such that:

$$L\_modified < L\_baseline$$

under substantially identical excitation conditions.

Reduction in trajectory length may occur with or without proportional reduction in convergence time.

In certain embodiments, convergence time is also reduced relative to baseline.

### Gradient Persistence Magnitude

Persistence magnitude M may be defined as magnitude of deviation of P(x) from baseline distribution.

M may be quantified through direct measurement of parameter-field deviation or indirectly inferred through dynamical evolution metrics including convergence time or trajectory length.

Persistence magnitude may vary continuously between baseline and fully accumulated reshaped states.

In certain embodiments, monotonic dependence is established such that:
M₁>M₂>M₃ corresponds to L₁<L₂<L₃ .

Controlled partial reset may reduce M without full restoration to baseline.

Partial reset mechanisms may include controlled thermal relaxation, sub-threshold excitation, reverse-bias electrical pulses, magnetic realignment pulses, or mechanical relaxation cycles.

### Multi-Domain NonLinear Architecture

In certain embodiments, the computing system comprises a plurality of continuous nonlinear physical domains.

Each domain independently comprises a spatially continuous parameter field P(x), nonlinear governing dynamics, an excitation interface, and a persistence modulation interface.

Domains may be physically separate substrates or spatially separated regions of a single extended substrate.

Each domain may operate under independent excitation and reset control.

### Staggered Persistence-State Operation

In certain embodiments, at least one domain operates in an accumulated reshaped persistence state while at least one other domain undergoes reset or controlled decay.

Domains may alternate roles according to a scheduling protocol.

Such staggered operation enables continuous computational availability without requiring global reset of all domains simultaneously.

In certain embodiments, persistence magnitude differs across domains, enabling layered computational timescales.

Outputs from multiple domains may be fused, selected, cascaded, or weighted based on persistence magnitude or convergence metrics.

### Persistence Governance Control Architecture

The system may include supervisory control circuitry configured to monitor and regulate persistence magnitude and domain scheduling.

Control circuitry may include digital processors, field-programmable gate arrays, mixed-signal control logic, microcontrollers, or application-specific integrated circuits.

The governance layer operates on dynamical evolution metrics rather than symbolic stored data.

In certain embodiments, persistence magnitude is estimated via measurement of convergence time, trajectory length, spectral analysis, or parameter-field sampling.

Reset scheduling may be triggered when persistence magnitude exceeds or falls below predefined thresholds.

Scheduling algorithms may minimize thermal accumulation, material fatigue, nonlinear instability, or entry into chaotic dynamical regimes.

### System-Level Stability and Constraints

Operation of the nonlinear domain may be constrained by thermal limits, material fatigue limits, nonlinear bifurcation thresholds, environmental perturbations, and measurement resolution limits.

Control circuitry may restrict excitation amplitude, duration, or frequency to maintain operation within stable dynamical regimes.

In certain embodiments, feedback from measurement interfaces dynamically adjusts excitation to avoid undesirable attractor transitions.

### Exemplary Optical Embodiment

In one embodiment, the nonlinear domain comprises a photorefractive lithium niobate (LiNbO₃) substrate.

Optical excitation may comprise a Gaussian beam having a characteristic width of approximately 2 millimeters.

Persistent reshaping may produce refractive index redistribution Δn(x, y) extending beyond 5 millimeters across the domain.

High-speed imaging at a sampling rate of at least 1 kilohertz may be used to compute dynamical trajectory length.

Reset may be achieved via controlled thermal annealing sufficient to restore baseline refractive index distribution.

### Exemplary Continuous Ionic Embodiment

In another embodiment, the nonlinear domain comprises a continuous silver-doped chalcogenide thin film.

Electrical excitation pulses induce spatial redistribution of conductivity across the domain.

Persistent reshaping modifies nonlinear conduction pathways.

Measurement may include monitoring current stabilization time and integrated deviation metrics.

Partial reset may be achieved through sub-threshold reverse bias pulses.

Full reset may be achieved through extended reverse bias or thermal relaxation.

### Exemplary Magnetic Domain Embodiment

In another embodiment, the nonlinear domain comprises a continuous ferromagnetic film.

Magnetic field excitation produces redistribution of magnetic anisotropy.

Attractor reshaping corresponds to altered magnetization stability basins.

Measurement may be performed via magneto-optical Kerr effect imaging.

Reset may be achieved via uniform magnetic realignment pulses.

### Exemplary Superconducting Embodiment

In another embodiment, the nonlinear domain comprises a continuous superconducting film.

Local current injection modifies superconducting phase stiffness distribution.

Persistent reshaping alters coupling coefficients governing phase evolution.

Reset may be achieved through controlled thermal cycling above critical temperature followed by re-cooling.

### Structural Exclusions

The disclosed architecture does not rely upon independently addressable discrete memory cells.

The architecture does not rely upon programmable weight matrices.

The architecture does not rely upon stored routing topology.

The architecture does not rely upon matrix multiply-accumulate computation structures.

Persistent reshaping is continuous, spatially coupled, and intrinsic to governing nonlinear dynamics.

1. A nonlinear physical computing apparatus comprising:
a continuous nonlinear physical domain governed by nonlinear differential equations dependent upon at least one spatially continuous parameter field;
at least one excitation interface configured to apply excitation to the domain;
wherein application of excitation produces persistent reshaping of said parameter field;
wherein said reshaping alters non-local coupling coefficients of the governing nonlinear equations and modifies attractor basin topology of the nonlinear dynamical system; and
wherein subsequent excitation exhibits a measurably modified dynamical evolution metric relative to baseline measured following reset of said reshaping, the dynamical evolution metric comprising at least one of state-space trajectory length, convergence time, stability eigenvalue spectrum, or basin boundary geometry.

2. The apparatus of claim 1, wherein state-space trajectory length L is defined as ∫∥dX/dt∥dt.

3. The apparatus of claim 1, wherein reshaping extends beyond a characteristic excitation scale.

4. The apparatus of claim 1, wherein reshaping modifies stability eigenvalues of at least one fixed point.

5. The apparatus of claim 1, wherein reshaping modifies basin boundary geometry between attractors.

6. The apparatus of claim 1, wherein convergence time is reduced relative to baseline.

7. The apparatus of claim 1, further comprising a persistence modulation interface configured to control magnitude of reshaping.

8. The apparatus of claim 7, wherein reshaping magnitude is continuously variable between a baseline state and an accumulated state.

9. The apparatus of claim 7, wherein at least one dynamical evolution metric varies monotonically as a function of reshaping magnitude.

10. The apparatus of claim 7, wherein reshaping magnitude is reduced via controlled thermal relaxation.

11. The apparatus of claim 7, wherein reshaping magnitude is reduced via sub-threshold excitation.

12. The apparatus of claim 7, wherein reshaping magnitude is reduced via reverse-bias electrical excitation.

13. A computing system comprising a plurality of nonlinear physical domains according to claim 1.

14. The system of claim 13, wherein at least one domain processes excitation while at least one other domain undergoes full or partial reset of reshaping magnitude.

15. The system of claim 13, wherein domains alternate between accumulated persistence states and reset states to maintain continuous computational availability.

16. The system of claim 13, further comprising supervisory control circuitry configured to schedule reset or persistence modulation operations.

17. The system of claim 16, wherein scheduling is triggered by one or more dynamical evolution metric thresholds.

18. The apparatus of claim 1, wherein the domain comprises photorefractive optical material.

19. The apparatus of claim 1, wherein the domain comprises a continuous ionic conductive film.

20. The apparatus of claim 1, wherein the domain comprises a magnetic domain material.

21. The apparatus of claim 1, wherein the domain comprises a superconducting phase material.

22. The apparatus of claim 1, wherein the apparatus lacks independently addressable memory cells.

23. The apparatus of claim 1, wherein the apparatus lacks programmable weight matrices.

24. The apparatus of claim 1, wherein the apparatus lacks matrix multiply- accumulate computation structures.
